(19) United States
(12) Patent Application Publication
(10) Pub. No.: US 2010/0312996 A1
(43) Pub. Date: Dec. 9, 2010

(54) SECURE SYSTEM FOR DATA TRANSMISSION

(75) Inventors: Bruno Aymeric, St Medard En Jalles (FR); Patrice Eudeline, Bordeaux (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, NEUILLY-SUR-SEINE (FR)

(21) Appl. No.: 12/809,584

(22) PCT Filed: Dec. 15, 2008
(86) PCT No.: PCT/EP2008/067559

§ 371 Date: Aug. 23, 2010

(30) Foreign Application Priority Data
Dec. 21, 2007 (FR) 07 09059

(51) Int. Cl. G06F 9/30

(52) U.S. Cl. 712/220; 712/E09.016

(57) ABSTRACT

The invention relates to a data transmission chain for a function of an aircraft onboard facility comprising a first computation chain and a second computation chain executing the same function as the first chain to validate the computation of the first chain, wherein the second computation chain uses the same hardware resources as the first chain and comprises, connected in series, a transformation means for transforming the input data, an acquisition means, the computer, a means for compensating the transformation and the comparison means, in such a way that the second computation chain executes a dissimilar computation from the first computation chain and the transformation compensation means makes it possible to compare the result data of the first and the second computation chain.

The field of the invention relates to onboard aeronautical facilities carrying out critical functions. More generally, the invention relates to any secure system, that is to say systems having to demonstrate a low fault probability.

For onboard facilities notably in the aeronautical sector, it is important to be able to demonstrate that the probability of certain events is low. The events are generally the occurrence of a hardware fault, with consequent erroneous behaviour, notably the display of incorrect information to a pilot for example, and the non-detection of this fault.

For some of these events, only a very low probability is tolerated. In the aeronautical world, this probability is expressed as number of events per flying hour. For the most critical events, it is necessary to demonstrate a probability of less than 10⁻⁹/hour. Moreover, for this kind of event, it is not tolerable that a simple fault is able to create the feared effect. For example, if a fault with a single particular electronic component can create the erroneous display of an information item, and if the probability of this event is of the order of 10⁻⁷/hour, then the design will be rejected by the certification authorities.

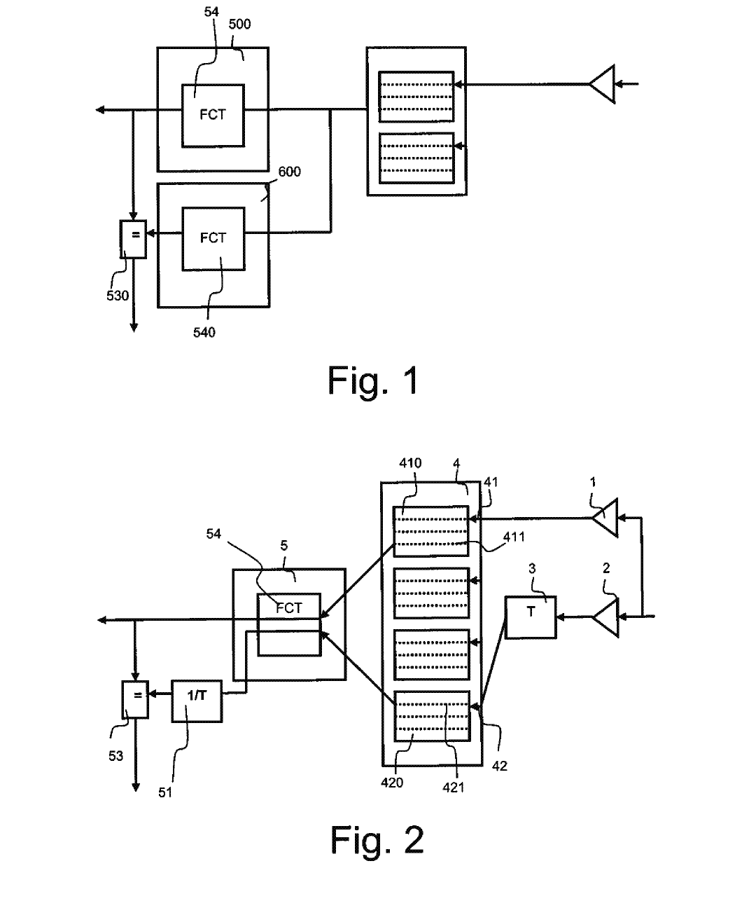

Thus the existing art consists in duplicating the computation chains, as is illustrated in FIG. 1. For example, one chain performs the computation 540 carried out by a computer 500 to provide the desired function, the display of an information item to the pilot, the other chain performs the same computation 540 carried out by another computer 600 to ensure that the first chain is operating correctly. The first chain is usually called COM for command, the other MON for Monitoring. If the MON chain detects an error by a result data comparison means 530, it generally has authority to deactivate the COM chain. It can also force a display so as to alert the pilots, or the operators in a more general case.

The function of the MON chain is generally two-fold. On the one hand, it makes the computations which are performed by the COM chain secure but it must also make the input data that the COM chain has taken into account to perform its computations secure.

Today it can be demonstrated that a simple hardware chain makes it possible to obtain secure computation. Indeed, the current architectures include:
robust schemes for sharing the microprocessor time as well as memories.
mechanisms for detecting and correcting errors in the memories making it possible to guarantee that an information item stored in memory will not be corrupted.

Thus, with the proviso that the MON chain performs a dissimilar computation relative to the COM chain, and that the memory resources used are different it is possible to demonstrate that the MON function can use the same microprocessor as the COM chain.

To obtain a real hardware mono-chain, it then remains to secure the input data of the computation. But the problem remains when a hardware fault occurs. Indeed, this fault must not cause an error in the computation of the COM chain which would not be detected by the MON chain. It would then be possible to imagine simply duplicating the input data acquisition electronics. The problem is that when COM and MON are accommodated by the same microprocessor, it is extremely difficult to demonstrate that a particular fault will not be able to give the same effect on the two computations. Indeed, it could be that the same bit of a data register is erroneous so that the input datum on COM and MON is identical but erroneous.

The document by PEERCY M et AL: “FAULT TOLERANT VLSI SYSTEMS” PROCEEDINGS OF THE IEEE, May 1993, number 5, pages 745-758 is known. This document describes error detection techniques for computers based on temporal redundancy.

More precisely, the invention relates to a data transmission chain for a function of an aircraft onboard facility comprising:
a first computation chain comprising a computer executing a function on a first datum recorded in a memory by an acquisition means and providing a first result datum, the first recorded datum being an input datum arriving at a first input of the acquisition means,
a second computation chain executing the same function as the first chain, providing a second result datum and comprising a comparison means for comparing the result data so as to validate the computation of the first chain.

The transmission chain is characterized in that the second computation chain uses the same hardware resources as the first chain and comprises, connected in series, a transformation means for transforming the input data, the acquisition means, the memory, the computer, a means for compensating the transformation and the comparison means, in such a way that the second computation chain executes the function on a second datum recorded in a memory, this second datum being the transform of the input datum by the transformation means and being recorded in the memory by the acquisition means in such a way that the computer executes a dissimilar computation from the first computation chain, and the transformation compensation means makes it possible to compare the result data of the first and the second computation chain.

Through these provisions, the invention does indeed achieve its intended aims:
A fault with the acquisition means addressing mechanism will be detected;
A fault with the acquisition means decoding mechanism will be detected;
The microprocessor executes dissimilar computations on data originating from different memory areas; a fault with the microprocessor and with the memory controller will then have different effects on the two chains. The monitoring chain will therefore detect the fault.

The term transmission chain is understood to encompass all the electronic means connected in series through which the data are transmitted, these electronic means being, not exclusively, the acquisition means, the transformation means, the memory, the computation means, the transformation compensation and data comparison means.

The transmission chain according to the invention exhibits numerous advantages among which:
The input data as well as the computations of the first chain are made secure by the second computation chain;
The secure computation chain is entirely hardware mono-chain entailing a reduction in the necessary hardware resources and therefore a reduction in the consumption, cost and weight of the onboard facilities concerned.

The invention will be better understood and other advantages will become apparent on reading the nonlimiting description which follows and by virtue of the appended figures among which:

FIG. 1 represents according to the prior art a computation chain made secure by hardware duplication.

FIG. 2 represents a computation chain made secure according to the invention.

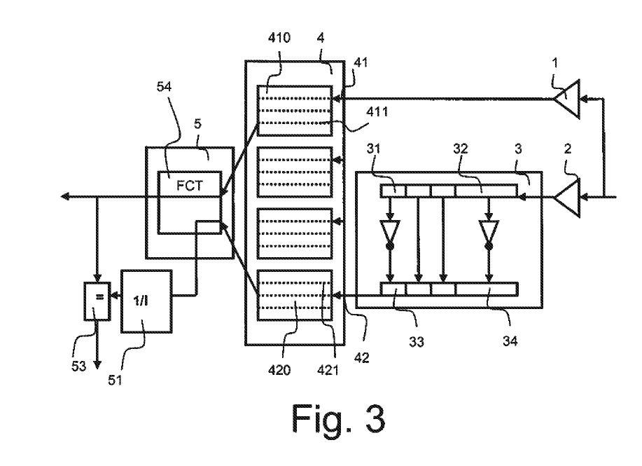

FIG. 3 represents a mode of implementation of the invention.

The person skilled in the art is well aware of the principle of making devices secure, such as those illustrated by FIG. 1. The computation chain is duplicated hardware-wise, using two microprocessors 500 and 600, to detect hardware faults, if any, with the microprocessor 500. The result of the first computation chain must be validated by the result of the second chain.

By way of nonlimiting example, FIG. 2 represents a data transmission chain of the “ARINC 429” standard of an onboard facility according to the invention.

Recall that the ARINC 429 bus is a standard developed specifically for the aeronautics sector. The principle of this data bus is known to the person skilled in the art. ARINC 429 is based on serial transfer of 32-bit words. Out of these 32 bits, 8 bits are reserved for the coding of a label number, each label corresponding to a type of information item, 2 bits to a status, (valid value, uncomputed value, value in error), 1 bit for a parity check, the others possibly being used to encode information.

The transmission chain according to the invention of FIG. 2 uses a single microprocessor 5 carrying out a computation function 54. To carry out the function the microprocessor must retrieve the data to be computed from memory spaces that may possibly be split into several memory resources.

The data transmission chain comprises a data acquisition means 4 comprising input links 41 and 42.

The acquisition means 4 is a circuit making it possible to de-serialize the data of ARINC 429 type originating from the serial buses 41 and 42. These input links can be connected to other onboard facilities communicating with ARINC 429 buses. The circuit 4 is capable of simultaneously managing some fifty or so input/output links. The input links comprise ARINC 429 bus demodulation circuits 1 and 2. The circuit 4 operates on the basis of detection of the label number and recording of the value coded in a memory allocated specially to each label. The memories 410, 420 differ hardware-wise and are not integrated into the circuit 4. The de-serialization circuit 4 addresses the data originating from distinct links 41 and 42 to distinct memory blocks. The data also being recorded at distinct memory addresses when the labels are different.

The first computation chain comprises the demodulator 1 connected to the input 41 of the de-serialization circuit 4. A first input datum is then recorded in a memory block 410 at an address 411. This memory address is addressed by the micro-processor 5 to retrieve the datum with a view to being computed by a function 54. This function thereafter provides a first result datum.

In order to prove that the reliability of this computation chain complies with the aeronautical constraints, a second computation chain is associated with this first computation chain. This second computation chain comprises a demodulator 2, a data transformation means 3 connected to another input link 42 of the circuit 4. The datum input to the datum transformation means 3 is the same as the datum input to the first computation chain.

Advantageously, the transformation means modifies the input datum into a second datum, the label of the second datum becoming a dissimilar label from the input datum in such a way that the acquisition means 4 addresses the second datum to a different memory address from that of the first datum.

Advantageously, the transformation means modifies the first input datum into a second datum, the information item of the second datum becoming a dissimilar information item from the information item of the first input datum.

The consequence is that the same input datum is recorded directly by the first computation chain and indirectly by the second computation chain via the data transformation means 3:
In two different memory blocks 410 and 420 since they originate from distinct input links 41 and 42;
In each block 410 and 420, at markedly different addresses 411 and 421 since the label number is different;
As transformed coding in one of the two blocks.

The fault modes of the acquisition means in the memories can be:
Fault with an addressing mechanism (the bit is frozen in a state): event entailing the overwriting of a certain address of a certain block by a datum which should have been stored elsewhere. The same overwriting will not be able to occur on the same block, since the data arrive at the acquisition means through distinct input links, and on the same address, since the transformed datum possesses a different label. The direct input datum and the transformed datum will then no longer be mutually compatible.
Fault with a decoding mechanism: event entailing the forcing of a data bit. The consequence is not the same on the two chains. The direct datum and the transformed datum will no longer be mutually compatible.

The monitoring chain will therefore have to take as input to the computer 5 transformed data, compensate the transformation by the means 51, and use these data to validate the computations of the COM chain with a comparison means 53. The MON chain executes the same function on a different datum from the COM chain. The computer 5 therefore executes a different computation for the two chains. Any fault at the level of the microprocessor or of the memory controller (bit forced to 1 or 0 for example) will then have a different effect on the two chains. The monitoring chain will therefore detect the problem.

In a mode of implementation illustrated in FIG. 3, the transformation means for transforming the input data 3 is a data inverter and the transformation compensation means 51 compensates the effect of the data inverter, the inversion consisting in transforming a “0” bit into a “1” bit and vice versa:
The data inversion means 3 has its output connected to a second input 42 of the data acquisition means 4;
The computer 4 retrieves the inverted datum from the memory 420 and provides an inverted result datum;
The compensation means 51 compensates the inversion on the inverted result datum and provides a second result datum;
The comparison means 53 of the second chain tests the first result datum with the second result datum and triggers an alert in case of non-agreement of the result data.

The input data of the ARINC 429 bus are transformed in an inverter before being recorded in the memory 420. An input datum comprises a label field 31 and a field 32 containing the information item to be decoded. In this mode of implementation, it suffices to invert these two fields. The label of the datum arriving at the input link 42 thus becomes totally different from the label of the input datum arriving at the input link 41 of the acquisition means. The bits of the decoded information item are also entirely different; the data bits all being inverted. The inversion function can be carried out easily on a reprogrammable circuit of “FPGA” (“Field Programmable Gate Array”) technology.

In this mode of implementation, the transformation means 3 is a data inverter, transforming a “0” bit into a “1” bit. This is the simplest transformation to implement and requires few hardware resources for setup. It is clear however that any other means of transformation modifying the data bits can be used. Nonetheless, the inversion of the data is the surest means for testing the computation chain since all the bits of the datum are modified. It is possible to use functions transforming the data partially at the risk that the fault lies on an unmodified bit and consequently causes the error detection to fail.

The invention also relates to a method of error detection for a data transmission chain, characterized in that the second computation chain carries out the following steps to validate the first result datum of the first computation chain:
in a first step, transformation of the input datum;
in a second step, recording of the transformed datum in a memory;
in a third step, reading of the transformed datum;
in a fourth step, computation of the second result datum;
in a fifth step, compensation of the transformation, carried out in the first step, on the transformed result datum, which step produces the second result datum;
In a sixth step, comparison of the first and the second result datum;
In a seventh step, if the results are different, deactivation of the computation chain and display of an alert for the operator.

This method is noteworthy since it makes it possible to detect an error in a computation chain the principle of which is based on the duplication of the computation chain while using a single hardware architecture. The characteristic of the method rests on the fact that the hardware resources are invoked to execute different operations while employing a means of inter-comparing the results of the computations at the end of the chain.

In the mode of implementation illustrated in FIG. 3, the second computation chain carries out the following steps to validate the result of the first chain:
In a first step, inversion of the input datum;
In a second step, recording in the memory of a second datum in a memory area, this second datum being the inverse of the first input datum;
In a third step, reading of the second datum;
In a fourth step, computation of the second result datum;
In a fifth step, compensation of the inversion on the second result datum;
In a sixth step, comparison of the first result datum and of the second result datum;
In a seventh step, if the results are different, deactivation of the computation chain and display of an alert for the operator.

Although the invention is developed for an ARINC 429 bus data transmission chain, it can be used for data buses of a different standard. Although particularly suited to digital data transmission systems in the aeronautical sector, the invention will not be confined to this sector of application. It applies to any device having to prove a low fault rate and could therefore also relate to space and automobile applications.

In our example, the invention applies to an aircraft display device carrying out functions involved in display and comprising a data transmission chain according to the invention for carrying out one of the functions. The invention also relates to any aircraft onboard device carrying out critical computation functions, comprising a data transmission chain according to the invention.

1. A data transmission chain for a function of an aircraft onboard facility comprising:
a first computation chain comprising a computer for executing a function on a first datum recorded in a memory by an acquisition means and for providing a first result datum, the first recorded datum being an input datum arriving at a first input of the acquisition means; and
a second computation chain for executing the same function as the first chain, for providing a second result datum and comprising a comparison means for comparing the result data so as to validate the computation of the first chain, wherein the second computation chain uses the same hardware resources as the first chain and comprises, connected in series, a transformation means for transforming the input data, the acquisition means, the memory, the computer, a means for compensating the transformation and the comparison means, in such a way that the second computation chain executes the function on a second datum recorded in the memory, this second datum being the transform of the input datum by the transformation means and being recorded in the memory by the acquisition means in such a way that the computer executes a dissimilar computation from the first computation chain, the transformation compensation means makes it possible to compare the result data of the first and the second computation chain.

2. The data transmission chain according to claim 1 whose data comprise at least one label and one information item, the label allowing the acquisition means to identify the datum and to record it in a precise memory area, wherein the transformation means modifies the input datum into a second datum, the information item of the second datum becoming a dissimilar information item from the information item of the input datum.

3. The data transmission chain according to claim 2 whose data comprise at least one label and one information item, wherein the transformation means modifies the input datum into a second datum, the label of the second datum becoming a dissimilar label of that of the input datum in such a way that the acquisition means addresses the second datum to a different memory address from that of the first recorded datum.

4. The data transmission chain according to claim 1, wherein the transformation means for transforming the input data is a data inverter and the transformation compensation means compensates the effect of the data inverter, the inversion comprising at least one of transforming a bit into a bit and transforming a 1 bit into a 0 bit, wherein:
the data inversion means has its output connected to a second input of the data acquisition means;
the computer retrieves the inverted datum from the memory and provides an inverted result datum;
the compensation means compensates the inversion on the inverted result datum and provides a second result datum; and
the comparison means of the second chain tests the first result datum with the second result datum and triggers an alert in case of non-agreement of the result data.

5. A method of error detection for the data transmission chain according to claim 3, wherein the second computation chain carries out the following steps to validate the first result datum of the first computation chain:
in a first step, transformation of the input datum;
in a second step, recording of the transformed datum in a memory;
in a third step, reading of the transformed datum
in a fourth step, computation of the second result datum;
in a fifth step, compensation of the transformation, carried out in the first step, on the transformed result datum, which step gives the second result datum;
in a sixth step, comparison of the first and the second result datum; and
in a seventh step, if the results are different, deactivation of the computation chain and display of an alert for the operator.

6. A method of error detection for the data transmission chain according to claim 5, wherein the transformation is an inversion of the data.

7. An ARINC 429 data transmission chain for carrying out the method according to claim 6, the data transmission chain comprising:
a first computation chain comprising a computer for executing a function on a first datum recorded in a memory by an acquisition means and for providing a first result datum, the first recorded datum being an input datum arriving at a first input of the acquisition means; and
a second computation chain for executing the same function as the first chain, for providing a second result datum and comprising a comparison means for comparing the result data so as to validate the computation of the first chain, wherein
the second computation chain uses the same hardware resources as the first chain and comprises, connected in series, a transformation means for transforming the input data, the acquisition means, the memory, the computer, a means for compensating the transformation and the comparison means, in such a way that the second computation chain executes the function on a second datum recorded in the memory, this second datum being the transform of the input datum by the transformation means and being recorded in the memory by the acquisition means in such a way that the computer executes a dissimilar computation from the first computation chain, the transformation compensation means makes it possible to compare the result data of the first and the second computation chain,
the transformation means for transforming the input data is a data inverter and the transformation compensation means compensates the effect of the data inverter, the inversion comprising at least one of transforming a 0 bit into a 1 bit and transforming a 1 bit into a 0 bit,
the data inversion means has its output connected to a second input of the data acquisition means,
the computer retrieves the inverted datum from the memory and provides an inverted result datum,
the compensation means compensates the inversion on the inverted result datum and provides a second result datum, and
the comparison means of the second chain tests the first result datum with the second result datum and triggers an alert in case of non-agreement of the result data.

8. An aircraft display device for carrying out functions involved in display, comprising a data transmission chain according to claim 4 for carrying out one of the functions.

9. An aircraft onboard device carrying out critical computation functions, comprising a data transmission chain according to claim 4 for carrying out one of the functions.
